(19) United States
(12) Patent Application Publication
(10) Pub. No.: US 2005/0199316 A1
(43) Pub. Date: Sep. 15, 2005

(54) METHOD OF WINCHING CUT TIMBER IN A FOREST AND A MACHINE DESIGNED TO ACCOMPLISH THIS

(75) Inventor: PUN CHOON ONG, Singapore (SG)

Correspondence Address: JAMES FREDERICK CHONG, 15 MCCALLUM STREET #13-04, SINGAPORE, 069045, SG

(73) Assignee: LOGFISHER TECHNOLOGY PTE LTD, Singapore (SG)

(21) Appl. No.: 10/708,559

(22) Filed: Mar. 11, 2004

(51) Int. Cl. A01G 23/08

(52) U.S. Cl. 144/335; 144/4.1; 144/34.1

(57) ABSTRACT

A method of retrieving cut logs in a forest, by a method of hauling, using a machine, being of an excavator body (4), with a modified back-hoe bottom arm portion that adapts to function as a boom (2), that has a winch pulley (1) at one end and a hydraulically powered reel (3) at the other, with this hydraulically powered reel strategically fitted above the excavator to optimize turning effect, and with the boom supported by a modified back-hoe forearm (11) and bucket (9), which provides operational efficiency and a high level of stability to the machine, being more productive while less damaging to the environment, which will be able to be deployed and re-locate more easily, being lighter and less cumbersome, haul from further distances, which is not so for prior art designs which have longer booms which encumber and contribute weight and which require a counterweight in terms of added machine chassis or added weights, which is more cumbersome than the present invention.

### BACKGROUND OF INVENTION

When trees are felled in forest harvesting, the felled trunks need to be retrieved. Many of the methods currently used cause a great deal of environmental damage and are not environmentally friendly. The following are current methods used to retrieve felled tree trunks:
a) Using heavy vehicles to skid the log over distances to the log collection point. This causes damage to the ground as well as damage to the log. The log's damage in this manner will affect its recovery of good quality timber.
b) Bringing in heavy vehicles such as crawler tractors to the site of the felled tree. This will cause damage to the surrounding area of the felled tree, including damage in making a pathway into the jungle for the crawler tractors to reach the felled tree. Growing saplings, and young trees are usually pushed over and destroyed in this method. Up to 60% of the harvesting area can be partially cleared and damaged in this process.
c) Helicopter lifting of logs. However this is costly and usually not cost efficient.
d) In Patent no GB2359001A, the design of a harvester has a long extended boom which will hoist the cut log over the air to the collection point. While this uses the principal of a cable and rises over the tree top thus saving the need to bring in heavy equipment to the felled tree, the limitation of this design is the length of the boom of the harvester. This is additionally, a constraint on the availability of large open spaces that would be required for efficient operation of the harvester, taking into consideration its large boom length.

Moreover, when the boom is too long, in excess of 60 m, the counterweight required on the harvester to balance the weight of the winched log would be required. A greater counterweight would require bigger harvesters and incur more costs.

Bigger harvesters are also more cumbersome to deploy and relocate when required. The stability of the harvester with very long booms are at question, and its overall effectiveness, while good at smaller ranges, is limited by its boom length.

Hilly undulating terrain with steep slopes also present a problem for the use of the design of patent no. GB2359001A, as the harvester therein is bulky and relocation is cumbersome. Also hilly undulating terrain presents problems and potential obstacles and range problems for the harvester with its long boom when it needs to be poised and positioned for effective hauling of logs.

When logging is taking place in tropical forest or where trees are very large, which can be 35 m to 55 m in height, and weigh around 2.5 to 4 tonnes, many other types of harvesters designed or available in the market are not made for such conditions. Such as (Bruun (1978) U.S. Pat. No. 4,114,666), (Sundberg et al Pat. (2002) U.S. 2002/0060199), (Kessler et al Pat. (1974) U.S. Pat. No. 3,805,859), (Gaudreault et al (2000), U.S. Pat. No. 6,135,175).

This present invention addresses the problem of retrieving large sized timber under steep terrain situations which pose a limitation to conventional logging techniques.

### BRIEF DESCRIPTION OF DRAWINGS

The following are the names of the parts in drawings of FIGS. 1 to 5

FIG. 1

The ‘Logfisher’ harvester
1—PUlly
2—Boom Arm
3—Winch Cable Reel
4—Engine part of harveter
5—Excavator Tracks
6—Operator's Cabin
7—Forward Chain Carrier
8—Grappler Claws
9—Bucket
10—Winching Cable
11—Backhoe fore-arm in Stabilizing position
12—Hydraulic Cylinders to control the arm movements.

FIG. 2

The Boom Arm
13—Reel
14—Winching Cable
15—Boom
16—Pulley System
17—Backhoe ‘forearm’
18—Bucket Hydraulic Cylinder
19—Bucket
20—Grapple Claw Hydraulic Cylinder
21—‘Fore-arm’ Hydraulic Cylinder
22—Grapple Claw
23—Solenoid Valve

FIG. 3

A figure of the winch reel at the end of the boom, and on top of the harvester body
24—Winching Cable
25—Cable Reel
26—Reel Mounting
27—Top of Operator's Cabin
28—Boom Arm Hydraulic Cylinder
29—Boom Arm

FIG. 4

Logfisher in position at the Landing Bay, ready to conduct winching operation up a slope (see diagrammatic illustration)
30—Winching Cable being extended down to the felled log.
31—Backhoe fore-arm with bucket in stabilizing position giving the harvester additional stability.
32—Logfisher Harvester in a stable position at loading bay area.
33—Depth of vertical distance from logfisher harvester to the cut timber is up to 1.5 km (1500 meters).
34—Horizontal Distance from Logfisher harvester to filled timber is up to 400 meters.
35—The fastening of the S-Ring, hook or similar noosing device.
36—Choker cable or chain to ring round the log and secure it.
37—The log which is to be winched up to the loading bay.

FIG. 5

This is a diagrammatic representation showing the position of the solenoid valve.

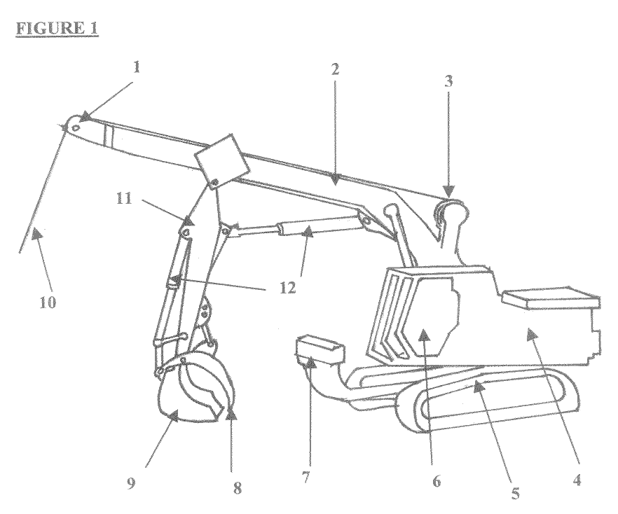

FIG. 5-1 The diagrammatic representation before the inclusion of the solenoid valve.

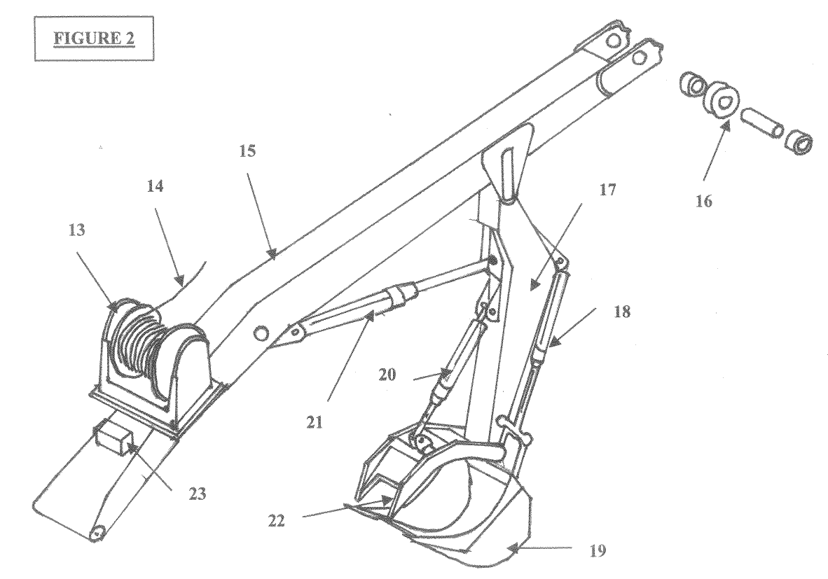

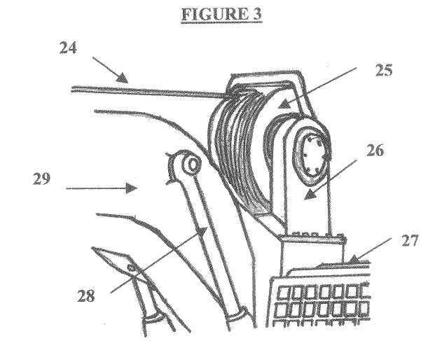

FIG. 5-2 The diagrammatic representation after the inclusion of the solenoid valve.
38—Hydraulic Pressure Pump
39—Centre Joint
40—Left Track Motor
41—Right Track Motor
42—Metal Pipes through which hydraulic fluid travels from the engine to power the reel.
43—Winching Cable Reel.
44—Solenoid Valve which enhances the power of the hydraulics to power the winch and through which the hydraulic fluid travels.

### DETAILED DESCRIPTION

### OBJECTIVE OF THE INVENTION

The purpose of this invention is to demonstrate a log winching machine whose effectiveness and function is not limited by the length of the boom, while being very stable due to the stabilizing arm, thereby requiring minimal intrusion and damage to the forest during forest harvesting, and therefore enabling commercial logging operations to take place while keeping to Forestry Preservation Principles set out by the Forestry Steward Council.

### SUMMARY OF THE INVENTION

A method of retrieving cut logs in a forest, by a method of hauling, using a machine (FIG. 1), being of an excavator body (4) (5) (6), with a modified backhoe bottom arm portion (2) that adapts to function as a boom (2), that has a winch pulley (1) at one end and a hydraulically powered reel (3) at the other, with this hydraulically powered reel (3) strategically fitted above the excavator to optimize turning effect, and with an appendage backhoe ‘fore-arm’ (11) fitted under the backhoe bottom arm portion to support the boom, providing leverage and stability to the excavator in the process of winching, therefore enabling greater efficiency and overall productivity of the machine and logging operation as a whole, which has not been able to be attained by other methods previously known.

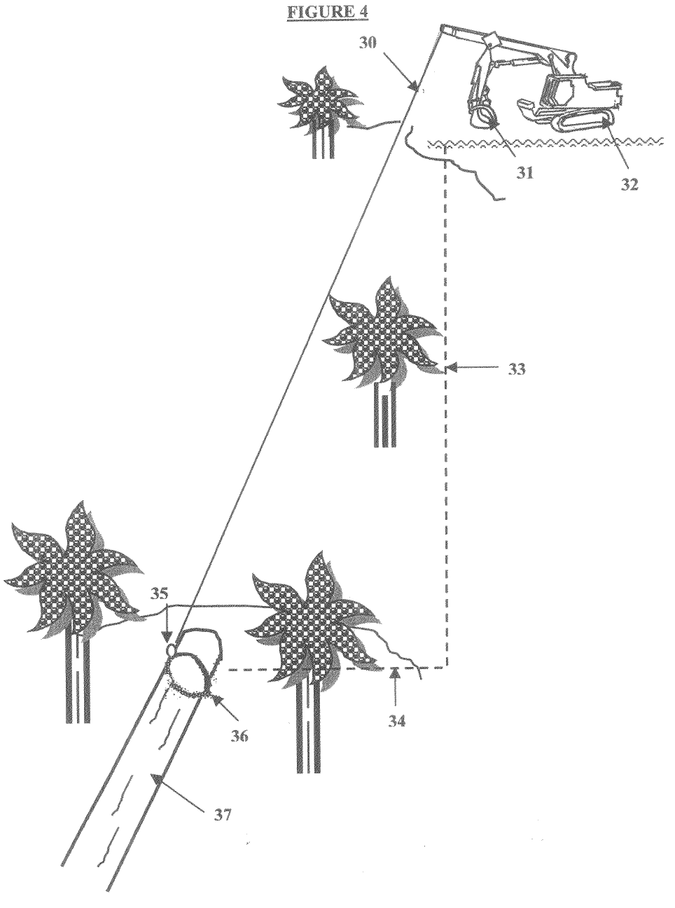

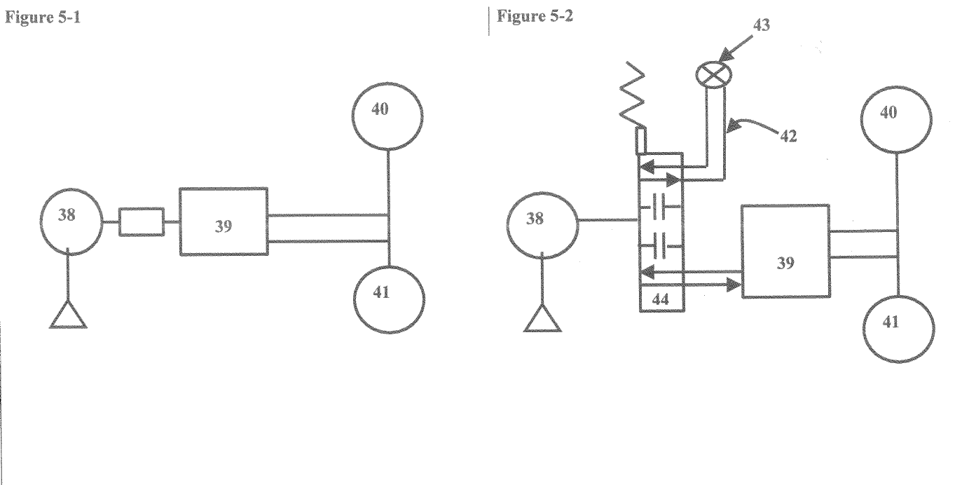

A description of the method of log retrieval is as follows (see FIG. 4, and Brief Description of Drawings on FIGURE 4).

The design of this invention is termed as the ‘Logfisher’.

1. Positioning

1.1 In order to determine the ideal position of the Logfisher, a supervisor and his assistant moves down into the area to locate the felled logs and to study the best alignment for winching the logs and to position the Logfisher. The Supervisor then moves back to the feeder road to direct the Logfisher to its intended position.

2. Positioning and Stabilizing the Logfisher

2.1 The operator of the ‘Logfisher’ moves into position (32) and prepares its staging point by clearing the site of wood debris, stumps and rocks which could in anyway interfere with its stability, especially when executing the winching operation.

2.2 The Logfisher is aligned to its most commanding and stable position within the staging point, and close to the edge of the slope, but sufficiently setback to ensure the Logfisher is stable.

2.3 Note that a single position of the Logfisher will be able to winch felled logs within the its arc of motion (rotation), which usually is the entire facing of the hill from where it is positioned. This increases productivity and efficiencies as the Logfisher need not be repositioned as often.

3 Clearing the Stump Site, Noosing the Log and Connecting the Winch

3.1 The area around the felled tree will also be cleared of any obstruction, including vines and other vegetation which may hinder movement of workers. Safety precautions are taken to provide an escape route for the workers in case of eventualities.

3.2 A Chain choker is placed around the circumference of the front end of the log, while field assistances bring in the cable.

3.3. The cable is lowered by two or three assistants pulling the cable end down as they walk down to the site of the felled log. They pull with their body weight as they move down which enables the unwinding of the winch cable. They communicate by walkie-talkie with the stump site assistant.

3.4 Upon reaching the felled log site, the end of the winch is hooked or fastened to the chain choker (or ‘S’-Ring).

4 Executing the Winch

4.1 Once the winch is secured to the choker, the supervisor instructs the Logfisher Operator by walkie-talkie to tighten the winch. The purpose is to firstly gauge that the chain choker is sufficiently secured, and also to gauge the weight of the log to know how much pull force is required to be exerted by the Logfisher Operator.

4.2 If the log is huge, and the weight considered is too heavy for the machine, this problem can be resolved by the assistants using a chainsaw to saw the log in half or other sizes and weight suitable weights for retrieval.

4.3 Taking into account the gradient of the slope, the weight of the log, the Supervisor will know much exertion is required by the Logfisher. He will take into account any obstruction in the terrain that is encountered. Field assistants will accompany the log as it is winched up the slope, and check for any obstructions along the way, including standing trees, and to readjust the choker alignment if necessary, and communicate with the logfisher if there is a need to realign path of travel of the log.

4.4 As the log nears the top, more force by the logfisher may be required as the trunk is set against the incline of the slope, and the operator of the Logfisher will increase power accordingly.

5 Top and Short Hauling.

5.1 At the top of the slope, the log normally rested on a perpendicular log, while the chain choker is repositioned by assistants to the center of the length of the log, so that it is easier for Logfisher to pull and drag it. The Logfisher can reverse using its tracks, which will drag the log to its intended location.

5.2 Another method by which the Logfisher performs short hauling winching, especially when a top of the log is jutting out from the slope and the rest of the log is still midway on the slope, is to apply a horizontal directional towing force by securing the log with a chain, and securing the other end of the Logfisher to the Forward Chain Carrier (7). In this way, when the Logfisher moves backwards, the log is pulled up the slope due to the horizontal force applied through the chain. This allows for a more effective application of force to pull the log along in the horizontal place, which takes over the role of the more vertical force of the boom, when the log is to be hauled at short distances at the log assembly yard ground level.

5.3 When sufficient logs have been retrieved to the collection zone, a timber lorry will arrive to carry the logs down to the next destination which is a log yard or mill.

1: A method of retrieving logs in a jungle, by means of noosing a winch (36) around one end of the log, securing it, and winching the log upward to the log assembly landing area which will be at higher ground, by a kind of machine described in claim 2, which has been completely redesigned and modified to perform winching operations effectively, efficiently, and with less cost and hardware wherewithal equipment than in any previous prior art designs.

2: A Machine to perform the method described in claim 1, the design of which is a composite of excavator features, (see FIG. 1), and described as follows:
a) Having an excavator body, including engine (4), tracks (5), and operator's cabin (6).
b) With an adapted backhoe bottom arm portion controlled by hydraulics, that is adapted to function as the main boom (2).
c) At one end of the boom is a winch pulley (1)
d) At the other end of the boom is a winch reel (3), strategically fitted to optimize the turning effect and stability of machine at high winching forces.
e) The reel is powered by diverting the engine hydraulic oil to power the reel, which passes through a solenoid valve enhancing the effect. (See FIG. 5).
f) An appendage backhoe fore-arm (11) fitted under the boom with multiple purposes being:
i. Supporting the boom, which gives great stability to the machine during winching operations, in particular when heavy loads of logs or such heavy material are being winched.
ii. An excavator bucket (9) being adapted to this machine is of a design with a broad ground surface contact, which provides excellent stability for the machine during high winching forces.
iii. The bucket with grappler arm act to carry logs and move logs as part of logging operation.
iv. The bucket can be replaced by a grappler to then have two grapplers which can carry logs and such material effectively.
v. The bucket also services multiple roles as an excavator in earth works.

3: A description of a machine as described in claim 2, which has a much shorter boom than in prior art designs, thereby being less cumbersome, less heavy in weight, and less expensive to build.

4: A Machine described in claim 3 and claim 2, which being lighter (as the boom is shorter) will not require a heavy counterweight to balance the machine, when heavy logs are being hoisted, as it is required in cases of large boom designs ascribed in prior art designs.

5: A Machine as described in claim 3 and claim 2, whose range of operational activity is not limited to the reach of the length of the boom, as it is with prior art designs.

6: A Machine as described in claim 3 and claim 2, whose boom being much lighter, thereby not adding to the weight of log to be hoisted, will be able to hoist logs located at greater distances away, as against prior art designs which have larger and heavier booms whose turning effect of the vertical component of its boom's weight, imposes a source of de-stability when a heavy load is lifted, and which require rectification by having heavy machine chassis and/or application of heavy counterweights.

7: A Machine as described in claim 3 and claim 2, which having a greater range, requires less occasion of pathways being cleared for the movement of machinery, thereby having less damaging environmental impact as it would be the case in other prior art designs.

8: A Machine as described in claim 3 and claim 2, which being lighter, less cumbersome, and with greater reach, is easier to deploy, more efficient and productive, at lesser costs, than prior art designs, and has higher yield and logging productivity rate than prior art designs.
